(19) United States
(12) Patent Application Publication
(10) Pub. No.: US 2002/0103750 A1
(43) Pub. Date: Aug. 1, 2002

(54) Renewable repriced mortgage guaranty insurance

(76) Inventor: Thomas Herzfeld, San Francisco, CA (US)

Correspondence Address: Sean P. Lewis, 7172 Regional #438, Dublin, CA, 94568, US

(21) Appl. No.: 09/972,564

(22) Filed: Oct. 4, 2001

Related U.S. Application Data
(60) Provisional application No. 60/238,244, filed on Oct. 5, 2000.

(51) Int. Cl. G06F 17/60

(52) U.S. Cl. 705/38

(57) ABSTRACT

A mortgage guaranty insurance policy is described having periodically adjusted premiums, the determination of said premiums being partially based on loan seasoning; and a claim settlement option chosen from the following: immediate lump-sum settlement, principal and interest payments being maintained for a fixed period prior to loan payoff, principal and interest payments being maintained until loan payoff is demanded by insured, principal and interest payments until the loan is paid off by the insurer. In one embodiment, the premium paid by the lender comprises the sum of individual premiums assigned to each loan in the insured portfolio, and each of said individual premiums are each adjusted according to separate fixed schedules. In another embodiment, the premium paid by the lender comprises the sum of individual premiums assigned to each loan in the insured portfolio, and said individual premiums are adjusted according to the same fixed schedule. In another embodiment, at least one premium adjustment includes a retrospective portion.

### BACKGROUND OF THE INVENTION

A. Field of Invention

This invention relates to Mortgage Guaranty Insurance. More particularly the present invention relates to a mortgage guaranty insurance policy that has particular features such as periodic repricing and unique claim settlement options.

B. Background Art

Mortgage guaranty insurance protects the mortgage lender from financial losses resulting from a borrower's default in paying a mortgage. Mortgage guarantee insurance transfers the risk of a mortgage default from the lender to the insurer. Typically, mortgage loans that have an excessive risk are likely to be insured. One common category of mortgage for which a mortgage guaranty insurance policy is often is issued is the low down payment mortgage. Experience has shown a strong correlation between the percentage of borrower equity in a property and the likelihood that a borrower would default on a mortgage secured by that property. For example, borrowers having little or no equity in a property tend to default more than those having ten percent or more equity, since the lower equity borrower stands to lose less through default.

Without mortgage guaranty insurance, lenders typically require a down payment of no less than 20 percent of the purchase price of the secured property. With mortgage guaranty insurance, a lender is willing to lend a greater proportion of that purchase price. The availability of mortgage guaranty insurance makes smaller down payments possible, and eliminates a major obstacle to a transaction that benefits the consumer (e.g., a home buyer) and the lender. Typically, such mortgage guaranty insurance policies are maintained until the outstanding principal has fallen below a percentage (e.g., 80%) of the purchase price.

The traditional mortgage guaranty insurance product is usually a borrower-paid, fixed premium insurance, with the cost or premium set at the time of loan origination. The traditional policy terminates only if canceled by the insured or for non-payment of premium. A principal advantage of this traditional product is that the terms of the coverage are certain, as long as the premiums are paid, for the life of the coverage. This certainty facilitates the origination, sale and resale of mortgage loans.

There is a need for new mortgage guaranty insurance products that allow a better allocation of risks between the loan guarantor (e.g., the insurer) and lender (e.g., mortgage owner). A principal disadvantage of the traditional product is that the terms are usually tied to a single loan of a single borrower and typically fixed at the time of origination for the lifetime of the insurance coverage. This traditional approach limits the opportunities to initially allocate and periodically reallocate risks among mortgage insurer, mortgage lender, or mortgage owner in a manner that can be structured to meet the needs and performance of the individual parties to a transaction and so thereby also promote the efficiency of the mortgage guaranty market.

The risks associated with a mortgage guaranty application fall into seven major categories:

The morale hazard of a lender taking less care with underwritten loans because of the insurance.

The adverse selection hazard that the insured will only insure the riskiest loans.

Bad risk persistency where lower credit quality loans tend not to prepay or refinance because of difficulties encountered in taking a new loan.

Interest rate increases leading to increased risks of loan default.

Changes in economic conditions (e.g., unemployment) other than interest rates may affect default rates.

Interest rate changes affecting the profitability of the loans aside from default represent lost financial opportunities that are typically uninsured (e.g., prepayment reducing lender's income stream; lost lender reinvestment opportunities if interest rates increase).

Heterogeneity of mortgages in a rate classification, increased loss variability increases the risk

In the traditional mortgage guaranty arrangement, the insurer bears the financial risks associated with the morale hazard, adverse selection, bad risk persistency, loan defaults due to interest rate increases, changes in economic conditions, and risk heterogeneity. The insured bears the non-default financial risks associated with interest rate changes.

The traditional system involves much market inefficiency. It allocates risks that are at least partially under the control of the lender (e.g., morale hazard, adverse selection bias, risk heterogeneity) to the insurer and thus substantially reduces the incentive of the lender to reduce such risks. Therefore, the insurer must charge a higher premium to account for any resulting unmitigated risks. The traditional system also places the burden or benefit of changing economic conditions as they affect the mortgage default rate upon the insurer. The traditional system also places the burden of lost investment opportunities and prepayment- related decreases in portfolio yields upon the insured. The traditional mortgage guaranty insurance premium inherently reflects these additional sources of risk according to their invariant allocation.

There is also a need to allow mortgage owners to optimize the cash flow from their investment, as well as the need for mortgage guarantors to have the ability to control loss payments to protect solvency during times of high mortgage default rates.

The traditional claim process on private mortgage insurance begins with the guarantor's receipt of notification from the loan's owner or servicer of a default on an insured loan. Default is typically defined in the primary master policy as the failure by the borrower to pay, when due, an amount at least equal to the scheduled monthly mortgage payment under the terms of the mortgage. Borrowers usually may cure defaults by making all delinquent loan payments or by selling the property and satisfying all amounts due under the mortgage.

Defaults that are not cured result in foreclosure by the loan owner and a claim to the guarantor. Under the terms of the master policy (or other agreement), the loan owner may typically be required to file a claim with the guarantor no later than 60 days after it has acquired good and marketable title to the underlying property through foreclosure. The claim amount includes (i) the amount of unpaid principal due under the loan; (ii) the amount of accumulated delinquent interest due on the loan (excluding late charges) to the date of claim filing; (iii) expenses advanced by the loan owner under the terms of the master policy, such as hazard insurance premiums, property maintenance expenses and property taxes to the date of claim filing; and (iv) certain foreclosure and other expenses, including attorney's fees. Such a claim amount is typically subject to review and possible adjustment by the guarantor.

After the claim has been filed, the guarantor typically may have the option of either (i) paying the coverage percentage specified on the certificate of insurance (usually 15% to 30% of the claim), with the loan owner retaining title to the underlying property and receiving all proceeds from the eventual sale of the property or (ii) paying 100% of the claim amount in exchange for the loan owner's conveyance of good and marketable title to the property to the guarantor, with the guarantor selling the property for its own account. In this case, the guarantor typically opts for the claim settlement option costing the least.

There are two reasons that the traditional method of settling claims in full with a single lump sum payment is sub-optimal for both the guarantor and the loan owner. First, it maximizes the present value of the claim amount and makes the payment at a time when it may not be optimal for reinvestment. If interest rates are falling it can reduce the duration and value of the loan owner's mortgage portfolio when it would provide maximum inconvenience to investors. Second, if market conditions are such that there are many defaults, foreclosures and claims, it could affect the solvency of the guarantor. Even if solvency is not impaired, the guarantors may be forced to exit the market, reducing the availability of mortgage loans. Mortgage guaranty insurance therefore becomes unavailable exactly when it should be most available to help rebuild the market. This happens because mortgage guaranty insurance is bound to the condition of the mortgage markets. This consequence of the traditional lump-sum approach is a source of instability in the industry. Insurance products should be insulated to the extent possible from the business cycles of the contingency insured. Otherwise, the insurance product may exacerbate business cycles rather than mitigate them.

Therefore, there is a need for a business method that approaches mortgage guaranty insurance according to the underlying risks, more flexibly allocates those risks according to the needs and loss experiences of the parties as well as changing economic conditions, helps the insured to optimize the cash flow from its mortgage portfolio and allows the mortgage guarantor to mitigate losses during times of high mortgage default rates. There is also a need for a business method that more effectively buffers the mortgage guaranty insurance and mortgage lending business cycles.

### SUMMARY OF THE INVENTION

A mortgage guaranty insurance policy is described having periodically adjusted premiums, the determination of said premiums being partially based on loan seasoning; and a claim settlement option chosen from the following: immediate lump-sum settlement, principal and interest payments being maintained for a fixed period prior to loan payoff, principal and interest payments being maintained until loan payoff is demanded by insured, principal and interest payments until the loan is paid off by the insurer.

In one embodiment, the premium paid by the lender comprises the sum of individual premiums assigned to each loan in the insured portfolio, and each of said individual premiums are each adjusted according to separate fixed schedules.

In another embodiment, the premium paid by the lender comprises the sum of individual premiums assigned to each loan in the insured portfolio, and said individual premiums are adjusted according to the same fixed schedule.

In another embodiment, at least one premium adjustment includes a retrospective portion.

### BRIEF DESCRIPTION OF THE DRAWINGS

FIG. 1 is a flowchart showing a method for calculating a mortgage guaranty insurance premium.

FIG. 2 is a flowchart showing a present invention method for settling claims.

### DETAILED DESCRIPTION OF THE INVENTION

The subject invention is a mortgage guaranty method and product which allows allocating risks among the mortgage owner and mortgage insurer by matching premiums more closely over time to the degree of a default or interest rate risk. The insured's risk sharing is thereby shifted to varying extents from loss variability to premium variability.

In one embodiment of the present invention a lender-paid, guaranteed renewal mortgage guaranty insurance is presented having fully delegated underwriting, periodic repricing based on changes in loan characteristics, with retrospective rating, and claims settlement options being selectable by the insured both at the time the policy is written and at the time a claim is made.

As in the typical prior art mortgage guaranty insurance policy the coverage is cancelable by the insured, which allows the insured to change policies in a competitive marketplace for insuring seasoned loans.

Repricing facilitates the insurance of loans of any age or seasoning, thus allowing the allocation of underlying risks and maintaining risk classification homogeneity.

Retrospective ratings reduce risk to the insurer by causing premium adjustments to reflect either or both of actual loss experience and the claims settlement options selected by the insured. Delegated loan-level underwriting is an option affecting the risk of default. However, periodic portfolio repricing and the retrospective rating used in repricing the coverage serve to mitigate the morale hazard. In this application, “periodic” includes a regular interval such as annually, monthly, every six months, etc., but also is intended to include irregular intervals, such as if a policy is typically repriced every six months, but is repriced off-schedule one or more times, such as at the fifth month since the last repricing event, or the eighth month since the last repricing event, or at any other time. The repricing may be done on any of several schedules, including but not limited to: for each individual loan whenever its characteristics change in some material way, a fixed interval for each individual loan, with different loans not necessarily having the same fixed repricing interval, and a fixed intervals for all insured loans, the actual schedule of the fixed intervals for all insured loans being primarily dependent on the origination date of each loan. Finally, repricing may also be performed at one time, for all loans owned by a particular loan owner. Under this scenario, all loans under a given loan owner would be repriced at the same time, regardless of when a given loan originated.

Optionally, the coverage provides claims settlement options, which allow allocation of interest rate risks between the insured and insurer. claims settlement options of various types will be discussed in later paragraphs.

TABLE 1
below summarizes features of one embodiment:

| Feature | Description |
|---|---|
| Lender-paid | Permits repricing without affecting amounts paid |
| | by the borrower to cover the owner's cost of |
| | insurance |
| Annually renewable | This aspect may be coupled with an annual repricing |
| | interval, but not necessarily. |
| Guaranteed | Provides insurability likely to be wanted by large |
| renewable | investors. Reassures investors especially until a |
| | competitive market for covering seasoned loans is |
| | developed. |
| Cancelable by the | This is a new feature of mortgage guaranty |
| insured | insurance, according to the present invention. |
| | It allows the insured to change insurers of |
| | seasoned loans if desired (not possible with prior |
| | art mortgage guaranty insurance products) |
| Periodic repricing | Given popularity of regular business and accounting/ |
| | reporting cycles in commerce, periodically allocates |
| | risk and maintains risk classification homogeneity |
| Retrospective rating | Reduces risk to the insurer and reduces average cost |
| | to the insured by adjusting premium to reflect actual |
| | experience. |
| Delegated loan-level | Part of the risk allocation process |
| underwriting | |
| Claims settlement | Allocates interest rate risk between insurer and |
| options | insured |

In another embodiment of a mortgage guaranty insurance according to the present invention, the insured is allowed to choose a method of claims settlement. Having the choice provides the insured with an opportunity to optimally balance interest rate risk, return maximization, and portfolio stability. claims settlement choices optionally include the traditional lump-sum payment to receiving the principal and interest payments as though the loan remained in force to full amortization. There are several options in between. Choices include, but are not limited to:

Immediate lump-sum settlement (traditional, in the field of Mortgage Guaranty Insurance)

Maintain principal and interest payments for a fixed period, known at policy issue, prior to loan payoff

Maintain principal and interest payments for a fixed period, unknown at policy issue, prior to loan payoff

Maintain principal and interest payments for a pre-defined period, unknown at policy issue, prior to loan payoff, e.g. portfolio duration at the time of the claim

Maintain principal and interest payments until loan payoff demanded by insured

Maintain principal and interest payments until the loan is paid off by the insurer at a time of its choosing.

Each settlement offer requires an adjustment to the estimated claim cost because the timing of claim payment stream affects its present value. Some of these adjustments can be made using standard discounting techniques; however, some require adjustment using option theory known to those of ordinary skill in the art.

In an alternative embodiment, the insurer chooses which settlement option to apply to a claim.

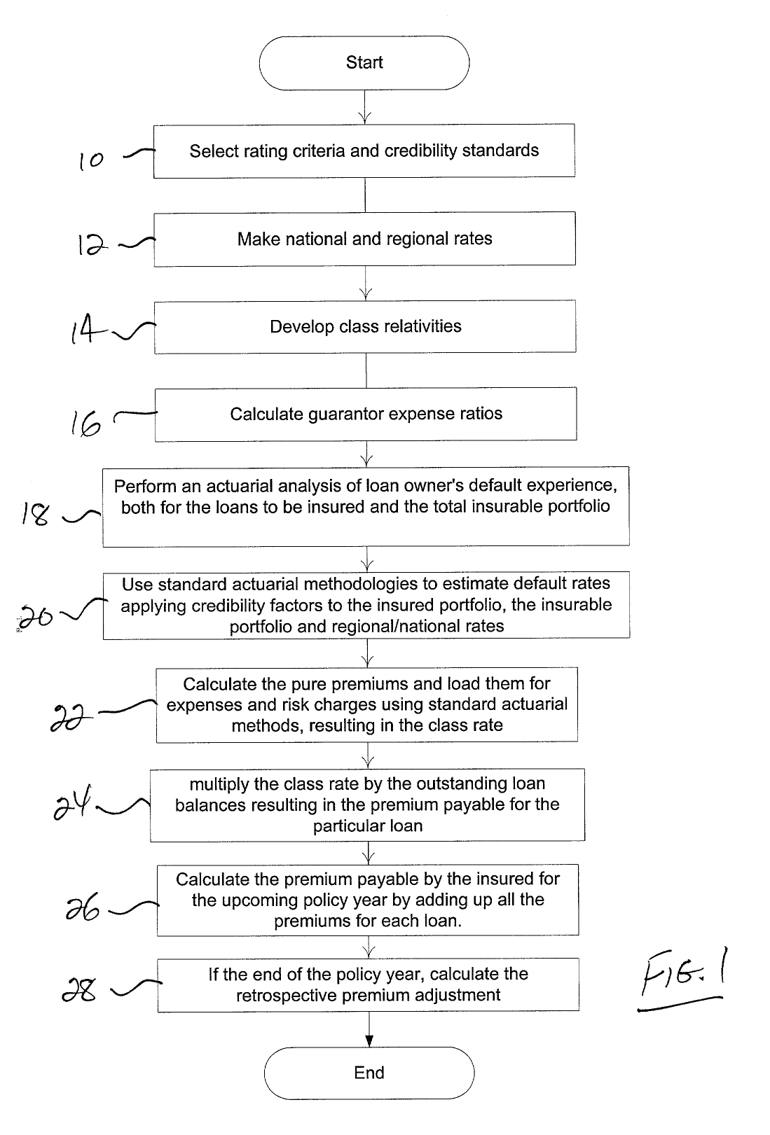

Describing yet another embodiment of the present invention, FIG. 1 is a flowchart showing a Method for Calculating a Mortgage Guaranty Insurance Premium. As will be appreciated by those of ordinary skill, this method has many features desirable to insurance carriers. For example, the method ensures that premium collected match the degree of risk at the time. Using the prior art methods, in the first few years, the premiums charged to the insured exceed the levels justified by the risk. During years four through six, the premiums charged are not adequate to support the levels justified by the risk. Following year six, the premiums charged again exceed the levels justified by the risk.

A second feature of the method of FIG. 1 is that risk and adverse selection is minimized due to the present invention premiums being consistent with the extent to which the insured portfolio is statistically different from the lender's insurable portfolio.

Other features of the method of FIG. 1 include the use of prospective and retrospective rate adjustments, the optional use of current Loan to Value (LTV) ratios, the use of credibility factors to combine experience based on small samples with experience based on larger samples the use of geographic and/or regional economic data, and the use of resale indices to estimate current LTV ratios.

Referring to FIG. 1, the method begins at block 10 where portfolio and loan rating criteria and credibility standards are selected. Example rating categories include, but are not limited to Loan seasoning, Loan geographic location and/or economic conditions at any or all of the local, regional and national levels, the loan owner's historical default experience and/or prospective loan owner's historical default experience, the difference to which the loan owner's portfolio of loans insured by the specific guarantor/insurer differs from the loan owner's total insured portfolio and total loan portfolio, the optional use of current Loan to Value (LTV) ratios, the use of credibility factors to combine experience based on small samples with experience based on larger samples, and the claim settlement option selected.

TABLE 2
Table 2 includes further optional risk rating categories.

Loan information
Loan provisions
Property location
Loan origination date
Interest rate
Loan original principal amount
Fixed/adjustable rate mortgage (FRM/ARM)
Term
Payment frequency
Other provisions, e.g., balloon payment, interest only
Points
Lender's loan number
Loan acquisition - originated or purchased
Loan disposition - sold or kept in originator's portfolio
Original LTV
Loan origination date
Loan acquisition date, if applicable
Date loan paid off, if applicable
Purpose of Loan - investment, residence etc.
Loan History since origination
Age (loan seasoning)
Interest rate and payment amount changes for adjustable rate mortgages
(ARMs)
Dates of late payments
Number of days payment was late
Filing date for notice of default if applicable
Date foreclosure started, if applicable
Date of foreclosure sale, if applicable
Property characteristics
Appraised property value
Property address, including street name, number and zip code
Property type
Single-family residence
Manufactured housing
Mobile home
Condo
Units
Borrower information
Name, address, SSN, other appropriate identification
Credit status A, B, C etc.
Date credit status determined
Credit rating score, converted to a quality percentile
Date of credit rating score
Loan payment history, if applicable
Fraud history, if applicable
Insurance characteristics
Coverage depth
Claims settlement plan
Other relevant information
Local economic indicators
Examples
Mortgage interest rates
Unemployment statistics
Real estate value trends
Local real estate market conditions
Local foreclosure rates
Regional economic, indicators
Examples
Unemployment statistics
Regional real estate value trends
Regional real estate market conditions
Local foreclosure rates
Other economic statistics and trend forecasts
General economic conditions
Examples
Unemployment statistics
Regional real estate value trends
Regional real estate market conditions
Local foreclosure rates

At block 12, national and regional rates are developed. Prior art approaches have operated using a single rate per class for an entire country. However, according to the present invention, regional rates are developed, in order to better match the rates used to the geographic location of either the loan owner or the borrower, whichever is deemed most relevant to the insurer. Basing rates on geographic location is a novel feature that may be used alone or in combination with other aspects of the invention, or with the prior art, while remaining within the intended scope of the present invention. An alternate embodiment would be to use a regional economic index score in addition to or in place of geographic location. These scores are available from services including Economy.com.

One way of developing rates is using the pure premium method (computing losses divided by exposure, for each class). However, those of ordinary skill in the art having the benefit of this disclosure will be readily able to develop rates using a number of different methods within the scope of the present invention.

During the process of developing class relativities, it may become necessary to use data from a wide variety of sources. Some sources contemplated by the inventor include HMDA reports, aggregated to the appropriate level of detail, HUD/FHA data quarterly and other HUD/FHA reports, Fannie Mae and Freddie Mac reports, Mortgage Bankers Association (MBA) reports, Mortgage Insurance Companies of America (MICA) reports, Company Loss Data, Resale value indices from Fannie Mae or Freddie Mac or Case-Schiller-Weiss or other indices whether developed or in development.

At block 14, class relativities are developed. As known to those of ordinary skill, a class relativity is a ratio of one class rate to a base class. Examples of classes include loans seasoned less than two years, a geographic region (for example, the southwestern portion of the United States, the northeastern portion of Mexico, etc.), an economic region (for example, the portions of the San Francisco Bay Area referred to as “Silicon Valley”), etc. An example base class would be the class of fixed rate loans with the least seasoning, lowest original LTV, and longest term, aggregated to the national level.

Those of ordinary skill in the art will readily understand how to choose a base class, and how to ratio other classes to the base class, in order to determine class relativities. The classes themselves are one novel aspect of the present invention. For example, using geographic regions as classes and using economic regions as classes is not seen in prior art mortgage guaranty insurance policies, and their associated methods of determining premiums.

At block 16, guarantor expense ratios are developed. These expense ratios are merely the ratio of costs associated with running the insurance business divided by the earned premium amounts or other amounts appropriate to the ratemaking calculation, for the periods being analyzed. These other amounts would be readily known to those of ordinary skill in the art.

At block 18, an actuarial analysis of the loan owner's default experience is performed, both for the portfolio to be insured, and for the loan owner total insurable portfolio. In some cases, the portfolio to be insured will be the same as the total portfolio, since the entirety of the loan owner's portfolio is to be insured. In other scenarios contemplated by the invention, larger loan owners may insure different parts of their portfolio with different insurers. In this situation, an actuarial analysis is performed on the loan owner's total insurable portfolio, and also on the portfolio to be insured by this insurer.

At block 20, loan default rates for the prospective insured are estimated using standard actuarial methods. Credibility factors reflecting the accuracy of the national, regional and local lender data are applied to the portfolio to be insured, the loan owner total insurable portfolio and the regional and national rates. Credibility factors represent the reliability of the data. In a system where credibility factors range from 0 to 1, a zero may indicate total unreliability, whereas a credibility factor of 1 would indicate total reliability, in that system. Those of ordinary skill in the art would be able to develop similar systems without departing from the scope or purpose of the present invention.

At block 22, the pure premiums are computed and loaded using standard actuarial methods, resulting in class rates.

At block 24, the premium is applied by multiplying the class rates by the outstanding loan balances, resulting in the premium payable for the given loan. For each loan intended to be within the insured portfolio, the premiums are added together at block 26, resulting in the premium to be paid to insure the entire portfolio.

At block 28, for years where prior year rates had been computed and are in place, adjustments may be made, resulting in a retrospective premium adjustment. The retrospective premium adjustment is computed using the following formula:

RA=MIN(C, MAX(A,B))−EP−RP,

Where

RA=retrospective premium adjustment

EP=Earned Premium (premiums paid for which the term has expired)

RP=Prior Retrospective premium adjustments (usually zero)

A=Minimum Premium payable, based on insured selection

C=Maximum Premium payable, based on insured selection

B=(ELC+RC+PEC+Actual Losses*Loss Expense Load)*(1+premium tax rate)

Where

ELC=Excess Loss Charge, the premium to cover losses above the maximum payable by the insured. This is calculated using standard actuarial techniques of calculating excess of loss premiums.

RC=Risk Charge, the risk charge for the policy, obtained using the factors from the premium calculation

PEC=Policy Expense Charge, the cost of issuing and maintaining the policy, including company overhead.

In an alternate embodiment, when computing renewal premiums, blocks 10, 12, 14, and 16 are optional.

In an alternate embodiment, rather than determining individual class rates and then multiplying those class rates by the outstanding loan balances and summing them, a weighted average of the class rates may be determined, and then the total outstanding portfolio balance may be multiplied by the weighted average, to determine the portfolio premium to be paid.

When it becomes necessary to adjust premiums, such as at a time for policy renewal, the method of FIG. 1 uses loan balances for the current year, estimated values are updated with projected resale factors, company expense charges are updated Use policyholder renewal rates calculated above and prior policy year rates to calculate rate adjustments for all rate classes, using standard actuarial techniques.

One actuarial formula for a mortgage guarantee insurance according to the present invention is based upon those used by life insurance actuarial methodologies:

$${A}_{x} = {\sum }_{t = 1}^{ω - x} {v}^{t} {*}_{t} \vert {q}_{x} * C ( t ) \vert where \qquad ( 1 )$$

A^{x} present value of the insurance

T=elapsed time

X=Seasoning

ω=the oldest possible seasoning. 30 years is typical.

qₓ=P(a mortgage with seasoning x will foreclose during the year) tlqx=P(a mortgage with seasoning x will foreclose between t and year t+1 years in the future)

C(t)=The claim factor for year t

v^{t}=The discount factor for t periods

C(t) is the amount of claim payable in year t. This means it includes all of the costs that arise from economic and other conditions; that is, all items that affect claim amount in a random, unpredictable fashion. Examples include the impact of ARM rate adjustments, changes in P(loss) due to changes in borrower creditworthiness.

Because

$${\sum }_{t = 1}^{ω - x} t \vert {q}_{x} = 1 \vert ,$$

it is a probability density function (pdf). It also means that Aₓ is an expected value. It is possible to combine the discount factor and the claim factor so that equation (1) becomes

$${A}_{x} = {\sum }_{t = 1}^{ω - x} t \vert {q}_{x} * C ( t ) \vert \qquad ( 2 )$$

This is the equivalent of an insurance of 1 using a discount function C(t).

In another method of the present invention, claim costs are adjusted to reflect the present value of the payment stream that replaces the prior art lump-sum payment. The adjustment to the claim costs reflects that claim payment is spread out over a period that may range up to the original mortgage term.

Methods of the present invention include claims settlement. Under prior art methods, the loan owner forecloses on the mortgage and files a claim with the insurer. The guarantor then settles the claim either by paying the coverage amount specified in the contract, or by paying the total loss and taking title to the mortgaged property.

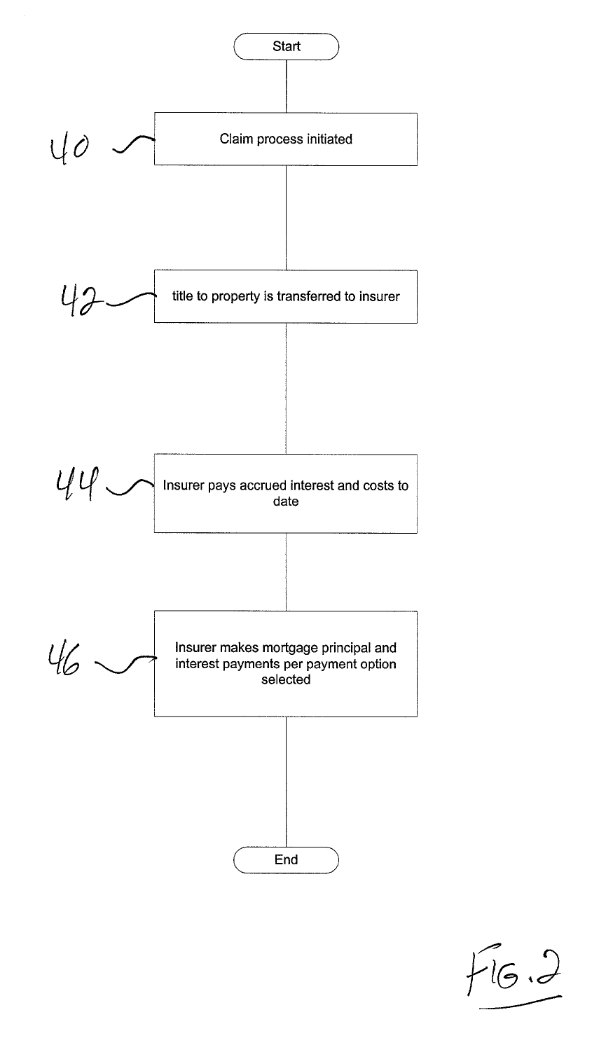

A present invention method of settling claims is shown in FIG. 2. Referring to FIG. 2, the method begins at block 40 when a Notice of Default is received by the insurer. Although receipt of a Notice of Default is a normal beginning point in the claims process, those of ordinary skill in the art will appreciate that there may be many other similar claims process beginning points that are within the scope and purpose of the present invention.

At block 42, title to the property in default is transferred to the insurer. At block 44, the insurer pays accrued interest and costs incurred by the loan owner to date.

At block 46, the insurer begins to pay the loan owner the principal and interest that the defaulting borrower would have paid, according to the schedule previously set forth in the loan terms. This payment scheme continues until a time set forth in the insurance policy. This time may be specified as a number of months after default, a number of months after loan origination, or any other suitable time.

In an alternate embodiment, the insured and the insurer agree at claim settlement that principal and interest payments will continue until for a specific period of time. Those payments continue for that time period at which time a lump-sum payoff is made by the insurer to the loan owner.

A preferred claims settlement option selection process according to the present invention would work as follows:

The loan owner would prepare an application and provide underwriting data, the loan owner would indicate the settlement options and conditions to be included in the agreement. Such options might include the traditional settlement choices of a percentage coverage or full property exchange in event of default; a lump sum payment option such as a lump sum payment according to the present value of the payment stream or commuted value of the arrangement; a fixed payment term option determined when the policy is written, renewed or renegotiated or determined at time of a claim; a variable payment term subject to loan owner call, guarantor choice, or a predetermined decision process or rule (e.g. the payment term is chosen according to general or particular market and/or economic conditions and/or other loan-related information). The application information is then submitted by the loan owner to the mortgage guarantor who processes the application for acceptance or rejection. If the application is accepted, the guarantor provides a rate quote and terms. The loan owner then reviews the rate and terms and may either accept or reject them. In the event of loan owner acceptance, the loan is accordingly insured with the guarantor. Thereafter, as specified by the terms of the insurance contract, the loan, in a preferred embodiment, is subject to periodic renewal and periodic repricing.

The specific embodiments described in the specification are not intended to limit the scope of the invention, but are only meant to provide illustrative examples within the spirit and scope of the invention. While particular embodiments of the subject invention have been described, it would be obvious to those of ordinary skill in the art that various changes and modifications to the subject invention can be made without departing from the spirit and scope of the invention. All such modifications are within the scope of this invention.

I claim:

1. A mortgage guaranty insurance policy comprising:
periodically adjusted premiums, the determination of said premiums being partially based on at least one of the following: loan seasoning, geographic location, regional economic conditions; and
a claim settlement option chosen from the following: Immediate lump-sum settlement, principal and interest payments being maintained for a fixed period prior to loan payoff, principal and interest payments being maintained until loan payoff is demanded by insured, principal and interest payments until the loan is paid off by the insurer.

2. The mortgage guaranty insurance policy of claim 1 wherein the premium paid by the lender comprises the sum of individual premiums assigned to each loan in the insured portfolio, and each of said individual premiums are each adjusted according to separate fixed schedules.

3. The mortgage guaranty insurance policy of claim 1 wherein the premium paid by the lender comprises the sum of individual premiums assigned to each loan in the insured portfolio, and said individual premiums are adjusted according to the same fixed schedule.

4. The mortgage guaranty insurance policy of claim 1 wherein said policy is guaranteed renewable for at least two policy terms during its lifetime.

5. The mortgage guaranty insurance policy of claim 1 wherein at least one premium adjustment includes a retrospective portion.

6. A method for managing a mortgage guaranty insurance policy comprising:
determining a first claim settlement method to be used if an insured event occurs;
determining a first premium amount to be charged, based partially on said first claim settlement method;
replacing said first claim settlement with a second claim settlement method; and
determining, if said first claim settlement method has been replaced, a second premium amount to replace said first premium amount, said second premium amount determination being at least partially based on the selected second claim settlement method.
